(19) United States
(12) Patent Application Publication
(10) Pub. No.: US 2026/0290183 A1
(43) Pub. Date: Sep. 24, 2026

(54) PERSONALIZED LEARNING SYSTEMS AND METHODS

(71) Applicant: Ella Language Learning Inc., Dover, DE (US)

(72) Inventors: Ziv YIRMIYAHU, New York, NY (US); Oren LAADAN, Singapore (SG); Giulia ROMEI, Dover, DE (US)

(21) Appl. No.: 19/571,300

(22) Filed: Mar. 18, 2026

Related U.S. Application Data
(60) Provisional application No. 63/773,689, filed on Mar. 18, 2025.

(51) Int. Cl. G09B 5/04; G06F 40/166; G06F 40/289; G06F 40/30; G06F 40/51; G06F 40/58; G09B 5/06; G10L 13/033; G10L 13/08

(52) U.S. Cl. CPC G09B 5/04; G06F 40/166; G06F 40/289; G06F 40/30; G06F 40/58; G10L 13/033; G10L 13/08; G06F 40/51; G09B 5/065; G10L 2013/083

(57) ABSTRACT

Systems, methods, and computer-readable media for personalized learning through content consumption. A learning platform receives content selected by or generated for a learner and processes it through a pipeline that includes content adaptation based on learner proficiency, speaker diarization, optimization for audio delivery, segmentation into manageable units, chunking into phrases using NLP-based linguistic analysis with hybrid LLM fallback and two-tier quality control, translation with phrase alignment using trace markers, and audio generation with accurate timestamp management.

### CROSS-REFERENCE TO RELATED APPLICATIONS

This application claims the benefit of and priority to U.S. Provisional Application No. 63/773,689 filed on Mar. 18, 2025 the entire contents of which are incorporated herein by reference.

### BACKGROUND

### Field of the Invention

The present invention relates generally to computer-implemented learning systems and methods, and more particularly to systems and methods for personalized, content-driven learning that dynamically adapts material to a learner's proficiency, interests, and goals.

### Description of the Related Art

Existing content-learning systems, such as language learning platforms, typically force learners to follow standardized curricula using material that is not relevant or interesting to the individual learner. As used herein, learning systems will be described primarily in the context of language learning, although other types of content-learning systems (such as test preparation, professional training, and the like) suffer from similar problems and are equally within the scope of the present invention.

Many people want to learn a foreign language, but most fail due to the effort and commitment required to achieve fluency. Traditional methods, such as interactive lessons that demand time outside of daily routines, often fall short in this regard. Traditional content-learning platforms require learners to carve out distinct blocks of time for stand-alone sessions that are generally disconnected from the learner's real-world context, making it easy for a learner to lose motivation. Furthermore, such platforms usually rely on fixed difficulty levels (e.g., beginner, intermediate, or advanced), which can result in material that is either too challenging for beginners or too simplistic for advanced learners-both scenarios leading to disengagement and poor retention.

Standard lessons in these platforms seldom offer genuine personalization. Rather than dynamically adjusting to learners' actual progress or known problem areas, they present all learners with the same content in the same sequence. This lack of tailored feedback and customized pacing means that learners receive either redundant information they have already mastered or insufficient support for new or challenging topics. As a result, these non-personalized, disconnected, and rigid study sessions do not provide the sustained, motivating experience needed to cultivate deep understanding or long-term mastery of a language or other topic.

Moreover, prior art learning systems that rely on artificial intelligence (AI) or large language model (LLM) processing face unique quality control challenges. LLM outputs are inherently non-deterministic and often inconsistent, and natural language processing (NLP) components may misinterpret structural or semantic cues. These reliability challenges are compounded when the output is intended for language learning, where linguistic accuracy is paramount. Prior systems generally lack robust mechanisms for detecting and correcting such errors in real-time processing pipelines.

Additionally, prior art systems that provide audio-based learning content typically deliver speech at a single, fixed pace, relying on mechanical tempo reduction that quickly sounds unnatural. These systems do not account for the fact that a language teacher naturally adjusts prosody, syllable emphasis, and word separation depending on the learner's native language and proficiency level.

Accordingly, there is a need for improved learning systems and methods that address the foregoing deficiencies.

### BRIEF DESCRIPTION OF THE DRAWINGS

FIG. 1A illustrates a high-level block diagram of a learning system pursuant to some embodiments.

FIG. 1B illustrates a detailed architecture block diagram of a learning platform pursuant to some embodiments.

FIG. 2 illustrates a content processing flow pursuant to some embodiments.

FIG. 3 illustrates a segment processing flow pursuant to some embodiments.

FIG. 4 illustrates frontend and backend interactions pursuant to some embodiments.

FIGS. 5A-5F are illustrative user interfaces of a learner interaction with a learning platform pursuant to some embodiments.

FIG. 6 illustrates a process for determining a personalized familiarity metric and partial translation decision flow pursuant to some embodiments.

FIG. 7 illustrates a quality control and fallback hierarchy flow pursuant to some embodiments.

FIG. 8 illustrates a chunking and cross-lingual alignment approach for phrase translation pursuant to some embodiments.

FIG. 9 illustrates a chunking with delimiter-based translation approach for phrase translation pursuant to some embodiments.

FIG. 10 illustrates a chunking with trace marker translation approach for phrase translation pursuant to some embodiments.

### DETAILED DESCRIPTION

### Overview

According to some embodiments, systems, methods, apparatus, computer program code, and means are provided for an improved learning system. The present invention provides significant technical improvements to facilitate the generation of customized learning content, including content segments and phrases that are dynamically generated based on the learner's proficiency, interests and learning goals.

Embodiments provide significant enhancements to traditional learning systems. For example, embodiments help learners succeed by creating a personal, audio-first content consumption experience. Some embodiments are particularly suited for language learning, although embodiments are not limited to language learning. Embodiments take any content that learners wish to consume and process it to allow learners to consume it in their preferred foreign language, adapted to the learner's skills, focusing on audio-first delivery with or without visual cues. The resulting audio alternates between the foreign language and the native language translation.

Embodiments allow learners to start consuming content of their choice in a foreign language of their choice with a single interaction. Embodiments make adjustments to tailor the content consumption experience in many ways, including suitable voice choice (accent, pronunciation, etc.), speech pace, audio volume, translation level, pause between phrases, and choice of vocabulary and grammar constructs. Embodiments may predict content (including words and phrases) that learners understand or do not understand and skip or emphasize them accordingly.

Unlike prior learning systems, embodiments do not force learners to interact with premeditated or canned content. Instead, learners are able to choose the content they learn from, allowing them to select content based on their interests. Embodiments allow full personalization to a learner's interests, enabling a learner to use any content—an article, a podcast, a video, or generated text—to be transformed into lessons at the learner's proficiency level. Embodiments provide real-time, data-driven adjustments to lessons ensuring the content is appropriate to the learner. Micro-lessons, inline explanations, and immediate translations ensure learners learn rules and words in the context of their preferred content.

### Technical Challenges

Allowing such personalized content in a learning environment comes with a number of technical challenges. For example, it is technically difficult to personalize content to a learner's proficiency level, past behavior, and learning goals. Adapting the content and text of the speech and audio (for both the original content and the translated content) presents further challenges. It is also a challenge to split content into phrases based on the learner's proficiency and preferences while keeping the translation of those phrases meaningful and in sync. Technical challenges also arise from the injection of additional content and/or speech (either integrated into the content or as supplemental content). The preparation of the audio to ensure natural speech when the content is split into phrases is also difficult, for both text-to-speech (TTS) generation and for the adaptation of original audio. Finally, it is a technical challenge to implement embodiments while reducing operational cost through on-demand processing of content, the use of caching and reuse of content, and through the optimized use of AI models.

### System Architecture

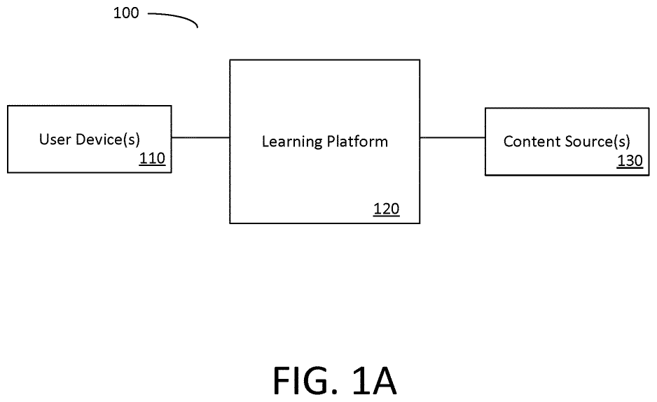

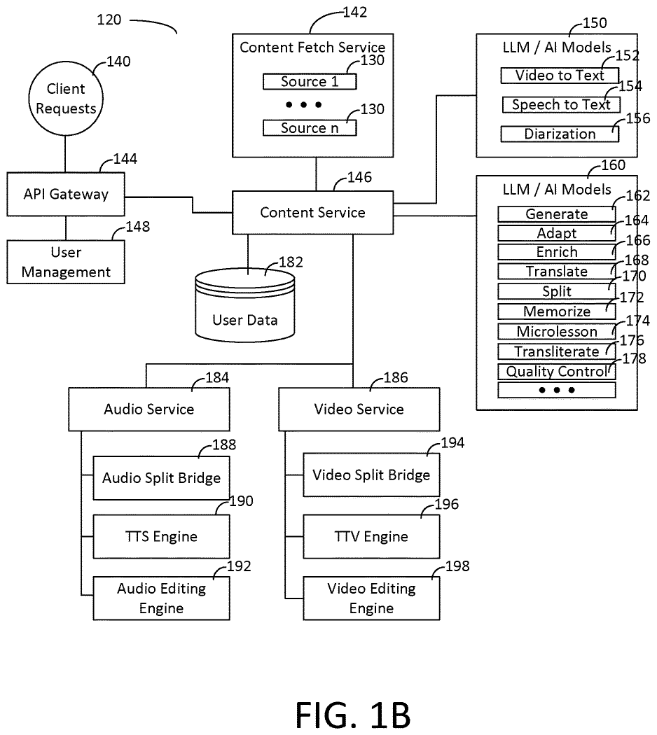

Features of some embodiments will now be described by reference to the figures. FIG. 1A is a high-level block diagram of a learning system 100 according to some embodiments. The learning system 100 includes one or more learner devices 110 (also referred to as user devices) interacting with a learning platform 120 to conduct learning interactions using content from one or more content sources 130. As used herein, the term “learner” is generally used to refer to an individual interacting with the learning platform 120 to learn or practice language or other skills. The “learner” may also be referred to as a “user”. The learning platform 120 may be configured to present language learning exercises and content to learners interacting with the platform via a learner interface presented on a learner device 110. Those skilled in the art will appreciate that the learning platform 120 is not limited to language learning but may be configured to present other types of learning content (e.g., test preparation content, professional training, etc.).

Pursuant to some embodiments, enhanced learning is facilitated by the learning platform 120 by allowing a learner to interact with content that is relevant to the learner, thereby making learning more enjoyable, engaging, and relevant. For example, in some embodiments, a learner learning a language may select content to be used in learning (e.g., an article, transcript, video, or other content). In some embodiments, the learning platform 120 may recommend or suggest content for consumption by the learner based on the learner's specified or detected interests, history, or proficiency. In some embodiments, the learning platform 120 may generate content for presentation to the learner. For example, the learning platform 120 may create or generate new text tailored to learner goals, such as simplified news summaries or custom lessons.

The content provided or selected by the learner may be in any of a number of different formats or types, including simple text, marked text (e.g., markdown, HTML), common document formats (e.g., PDF, DOCX), images via optical character recognition (OCR), audio via transcript or speech-to-text engines, or archived payloads. The content may also be provided by reference to a URL, a website, or a streaming service (e.g., video hosting platforms, podcast services, and the like). Pursuant to some embodiments, a learner may select content using various input methods, including: entering or copying content directly into an input field of the user interface, using browser extensions that allow the learner to mark content on any webpage and send it for processing, emailing the content to the learning platform 120, sending the content via a messaging application, sharing the content from another application on a mobile device to the learning platform 120, connecting to an RSS feed and selecting from the feed, or the like.

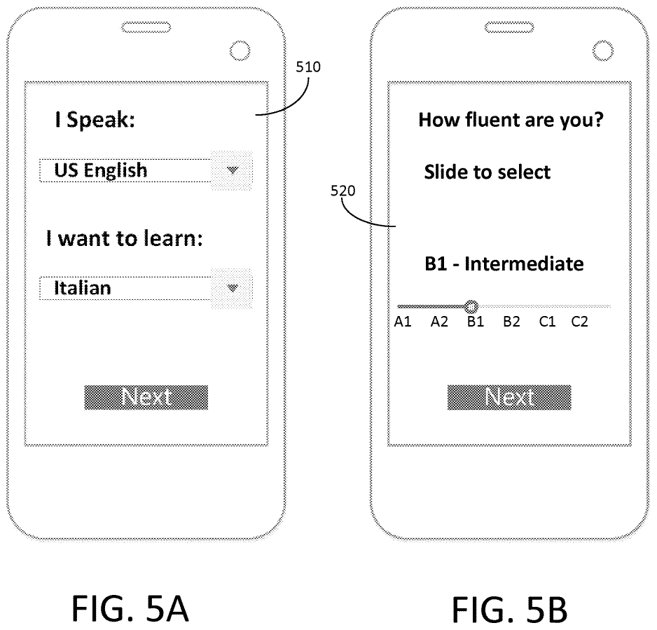

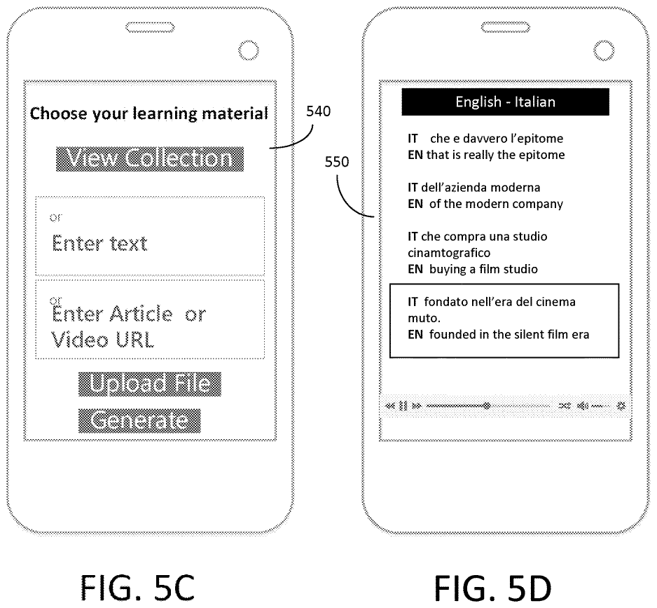

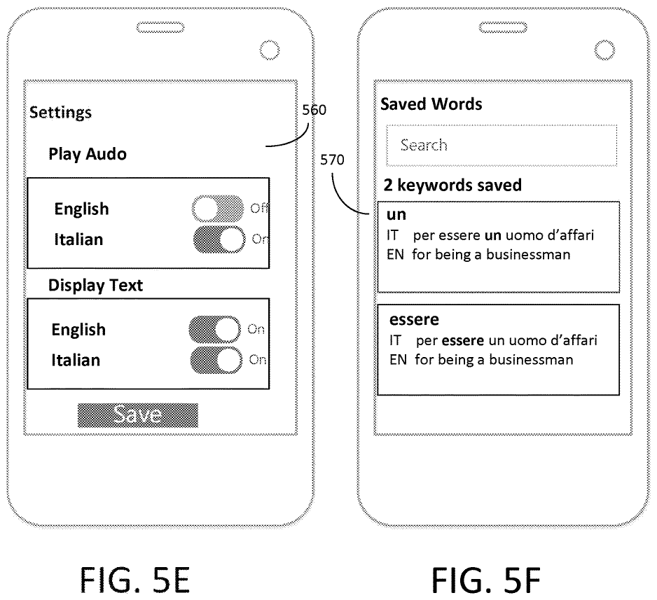

Example user interfaces are shown in FIGS. 5A-5D which show sample interactions that a user may experience while interacting with the learning platform 120. For example, FIG. 5A shows a user interface 510 in which the user interacts with the learning platform 120 to select a language to learn. FIG. 5B shows a user interface 520 which allows a user to select their current proficiency level. This proficiency level will be used to calibrate the content and pacing of learning for the user as described further herein (and may be modified or adapated by the learning platform 120 based on the user's interactions). FIG. 5C illustrates a user interface 540 that allows a user to select or upload content to use in learning (e.g., by selecting content from a collection of content provided by the learning platform 120, by entering text, by entering a URL of an article, video or other source of content, or by uploading a file). Those skilled in the art, upon reading the present disclosure, will appreciate that other sources of content may also be used. Once content is selected, a user interacts with the user interface to generate audio for the content in the language selected in FIG. 5A. The user can then interact with a user interface 550 (FIG. 5D) to listen to the audio playback of the content and to visually see the translated content. A number of user preferences or settings can be applied to customize the user's interactive experience (e.g., as shown in user interface 560 of FIG. 5E). The user can also interact with the user interface to select or mark words or phrases for further lessons or to incorporate those words in mini-lessons. An illustrative user interface 570 (FIG. 5F) depicts an example of how saved words can be reinforced for the user. Those skilled in the art will appreciate that these user interfaces are illustrative and that a wide variety of user interfaces and experiences may be provided to enhance learning and retention of a user.

Further details of components of the learning system 100 (with a particular emphasis on components of the learning platform 120) are shown in FIG. 1B, which depicts the architecture of the system pursuant to some embodiments. Client requests 140 from the user device 110 (e.g., such as a mobile app, web app, or desktop application) reach an API gateway 144, which performs standard authentication and authorization, and then proceed to a content service 146. The content service 146 orchestrates the sequence of steps needed to satisfy user requests, primarily requests to add content and to consume content. The content service 146 is also responsible for proactive steps such as pushing content to the learners (e.g., for display and interaction on a user device 110 in communication with the learning platform 120). A user management service 148 handles user authentication and profile management. A users data database 182 stores learner profiles, consumption history, familiarity metrics, and other user-specific data.

Adding content (typically selected by the user) begins with invoking a content fetch service 142 to fetch the content from a selected content source 130 (e.g., such as blogs, web pages, email, podcasts, video streaming services, or the like). The learning platform 120 includes, or is in communication with, one or more LLM/AI models 150 for transcription, including, for example, one or more video-to-text service 152 and one or more speech-to-text service 154. These services 152, 154 may be used to extract the content from non-textual media forms. In some embodiments, the LLM/AI models 150 may include models to perform diarization 156 of speakers (e.g., to identify which person is speaking in a multi-user conversation and at which position in the playback stream the person is speaking in the form of start/end timestamps around the text spoken by each speaker).

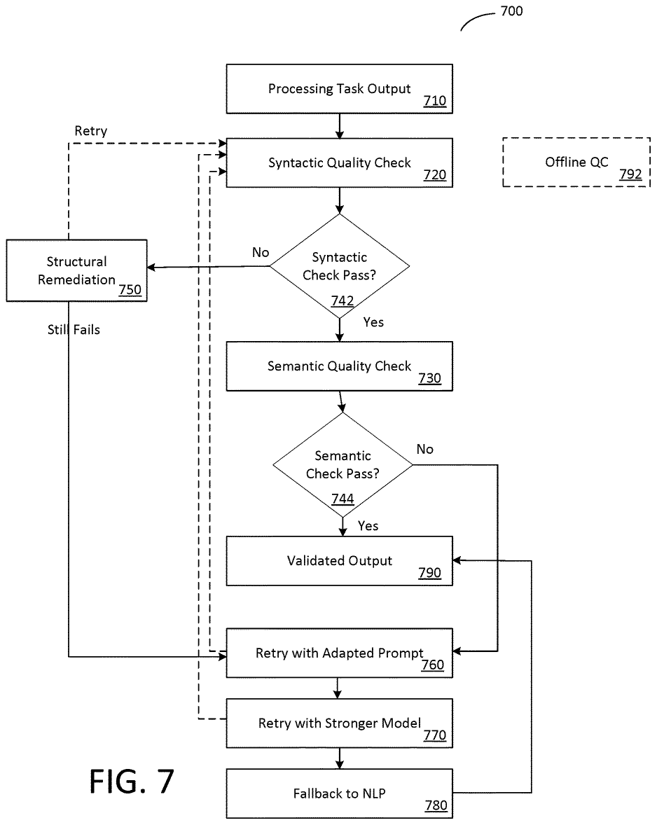

As shown in FIG. 1B, the content service 146 orchestrates multiple processing steps using LLM/AI models 160 for content processing. These processing modules include a generate module 162 for creating new content, an adapt module 164 for adjusting content to learner proficiency, an enrich module 166 for adding supplemental learning material, a translate module 168 for translation between languages, a splitter module 170 for dividing content into phrases, a memorize module 172 for vocabulary retention aids, a micro-lesson module 174 for generating focused teaching units, and a transliterate module 176 for converting scripts. A quality control module 178 monitors the output of these processing steps as described in further detail below with reference to FIG. 7. The splitter module 170 may comprise multiple modules to perform different split operations. For example, one module may operate to split the entire content into smaller segments (or units of processing). This may be done early in the process to avoid pre-processing the full content and reduces latency of first playback to the user and reduces costs if the user does not finish the entire content. This module may generally be referred to as a “segmentize” module. Another module may be operated to split a segment into chunks/phrases (or units of speech). This is part of the processing of a segment. Chunks and phrases are the basic unit of playback and this may generally be referred to as “chunking”

Processed content is delivered via an audio service 184 and a video service 186. The audio service 184 includes an audio split bridge 188 for dividing audio at phrase boundaries, a text-to-speech engine 190 for generating audio from text, and an audio editing engine 192 for repairing and modifying audio. The video service 186 includes a video split bridge 194, a text-to-video engine 196, and a video editing engine 198. Further details of the operation of the learning platform 120 will be described further below.

### Content Processing Pipeline

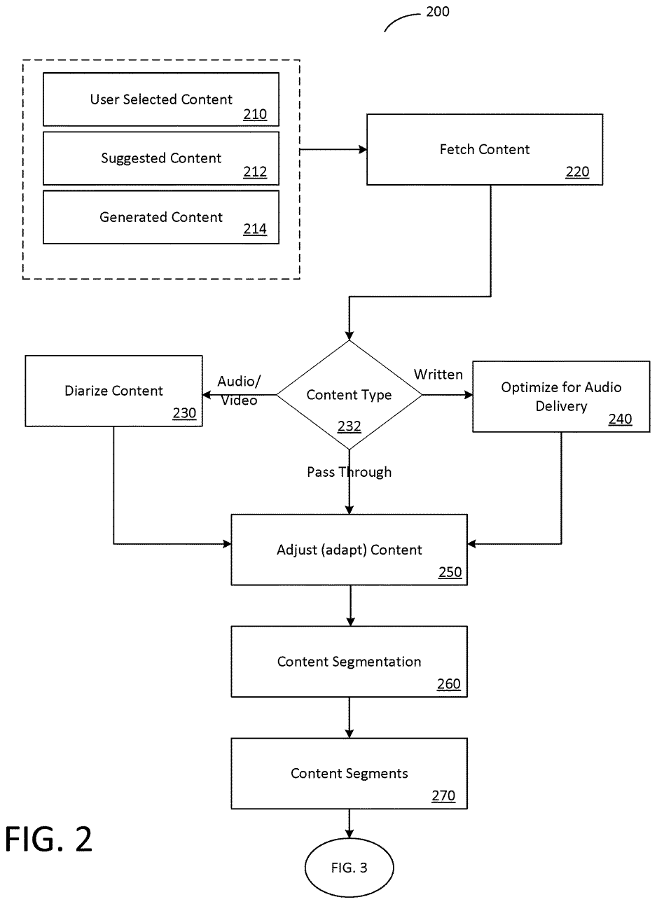

A content processing flow 200 pursuant to some embodiments is shown in FIG. 2. The content processing flow 200 may be performed by the learning platform 120 in response to interactions by a user. Content enters the pipeline from one of several content sources: user selected content 210, suggested content 212, or generated content 214. The content is first retrieved by a fetch content process 220. For audio or video content involving multiple speakers, a diarize content process 230 identifies and separates different speakers (described in further detail below). The diarize content process 230 may also be used to identify and separate different speakers from textual content (e.g., such as situations where the textual content includes dialogue, conversation or quotes where the speakers are not explicitly indicated in the textual content). For written content being converted to audio, an optimize content for audio delivery process 240 adapts the text for the audio medium (described in further detail below). The content then undergoes an adjust (adapt) content process 250, which modifies the content based on the learner's proficiency, preferences, learning goals or objectives, and history. A content segmentation process 260 divides the adapted content into content segments 270 for further processing. While the foregoing has been described in a sequence, the sequence is solely for the purpose of describing FIG. 1B. For example, the content segmentation process 260 is typically performed first (to avoid processing the full content as it can be costly and time consuming). Further, the processing can be dynamic—the segment size may be adjustable (with the first segment typically smaller to serve the user as fast as possible and subsequent segments longer as there is more time to generate audio while the user consumes the first segment). In some embodiments, multiple segments may be processed (e.g., where larger context is useful or important for the operation). For example, looking at wider context for micro-lessons allows more flexibility to optimally combine the micro-lessons with existing text. As another example, if a segment ends in the middle of a sentence (or paragraph), the following segment may be larger (and may include some overlap of the prior segment). This allows context to be maintained. The overlap may be multiple sentences to ensure sufficient context is provided. The order of processing is not fixed, and the processing order may change and different processing steps may be combined (or split). For example, when an LLM is involved in one or more processing steps, multiple steps may be combined. Further details of the processing steps will be provided below.

### Transliteration

While, in some embodiments, the system 100 is audio-first, the content is simultaneously delivered on-screen in writing and in synchronization with the audio, in both the learned language and the native language. For example, in some embodiments, a user can select, per language, whether to show the text on-screen via a settings user interface 560 (FIG. 5E).

It is not uncommon for a foreign language to use a script unknown or only partially known to the learner. For example, languages such as Hebrew, Arabic, Greek, Chinese, Japanese, Russian, and many others use their own non-Latin scripts. For such cases, pursuant to some embodiments, the transliterate module 176 (FIG. 1B) can generate a transliteration of the foreign language text to a script that is familiar to the user. Transliteration converts the representation of text from one writing system to another without translating its meaning, allowing learners to read the pronunciation of foreign-language content in a familiar alphabet. For example, in some embodiments, the user can select whether to show transliterated text on-screen via a display transliteration toggle in the settings interface 560 (FIG. 5E).

### Speaker Diarization

As shown in the diarize content step 230 of FIG. 2, when the content for consumption originates from audio sources (e.g., a podcast, video soundtrack, or call recording) or from textual content with multiple speakers that are not clearly identified in the textual content, the diarize module 156 (FIG. 1B) identifies and separates different speakers within the audio recording. Diarization automatically determines who is speaking at each moment in the audio. This is particularly important for audio content involving multiple hosts, guests, and interviewees who speak in turns or occasionally overlap. For these cases, diarization is critical to produce clear and structured transcripts and to improve comprehension for listeners. In later processing steps when new audio is generated by the text-to-speech engine 190, different synthesized voices are used to represent different speakers.

Similar processing is needed to identify multiple speakers even for non-audio content, where the text may represent multiple speakers. Consider, for instance, a written interview or a conversation from a book, where not every quote is explicitly accompanied by the speaker's identity. For this purpose, the diarize module 156 combines NLP tools and LLM engines to correctly identify neutral text, narrator text, and individual speakers' text in the content.

### Optimizing Content for Audio Delivery

As shown in the optimize content for audio delivery process 240 of FIG. 2, when converting written content such as blogs, news articles, reports, or emails into audio for learning consumption, the system adapts the text for the audio medium. Written content often relies on visual cues, formatting, and reader-controlled pacing, none of which translate directly into audio. For example, references like “as shown in FIG. 2” or “see the previous paragraph” make sense in a document but confuse audio listeners if not rephrased. As non-limiting examples, other elements that require adaptation may include abbreviations or symbols requiring visual understanding, parenthetical remarks, complex punctuation cues, formatting cues, footnotes, bibliographic numbers, paragraph numbers (e.g., in legal documents), and page numbers.

Pursuant to some embodiments, the learning platform 120 combines NLP tools and LLMs to adapt the text for audio delivery. NLP techniques assist with entity and reference detection, including footnotes, citations, numbers, lists, and tables. LLMs can then rewrite content references to be more audio-friendly, simplify dense text, and add audio-friendly transitions. By systematically identifying and transforming these elements, the optimize content for audio delivery step 240 ensures that the content is both understandable and engaging for audio audiences while preserving the original text's intent and information.

### Content Delivery Framework

Embodiments provide a content delivery framework to convey the designated content to the learner. The framework is designed to facilitate flexible, efficient, and highly expressive content delivery. In this method, content is divided among one or more speakers, rotating content delivery between them. Speakers can represent languages (e.g., foreign vs. native), roles (e.g., original text vs. teacher), narration, and actual speakers (e.g., content of an interview or panel discussion).

More specifically, content of any kind is first adapted and enriched, and then split among speakers based on semantics or roles. The content of each speaker is then split into phrases based on the use case. The content in phrases may undergo further enrichment. For example, if the content involves different characters or speakers, the content is delivered by the speakers alternating turns in a preset order, such that each speaker delivers one corresponding phrase per rotation until all phrases have been presented.

Pursuant to some embodiments, phrases may include content not intended to be narrated, such as extra visual content to be displayed only (e.g., a title, a side-comment, teaching material, image, or animation) or special instructions to the player application on the learner device 110 (e.g., play a sound effect, place a frame around content on the screen, change language or speech properties, and the like). This framework facilitates flexible, efficient, and highly expressive content delivery. For example, language learning would normally use two speakers (one per language) that alternate in narration, so the learner hears each phrase in both languages one after the other. Teaching commentary can be delivered using a third speaker or via special player instructions. Arbitrary teaching material can accompany the delivery in visual form. As another example, test preparation content (e.g., SAT preparation) would typically use one speaker, with commentary added visually and using special player instructions. In another scenario, delivering an interview or group discussion would typically use one speaker per participant.

Pursuant to some embodiments, the order of presenting content between the foreign language and the native language may relate to the learner's learning objectives. When the foreign language is presented first and the native language second, comprehension is emphasized because learners are encouraged to first translate the content mentally before hearing the translation, thereby improving passive listening skills. When the native language is presented first and the foreign language second, the learner is encouraged to first translate into the foreign language before hearing the translation, thereby boosting active speech generation skills. Applicants have found that this distinction between passive and active learning modes provides pedagogically meaningful differences in learning outcomes. In some embodiments, the system may dynamically switch between these modes based on the learner's proficiency and learning objectives.

### Segmentation Algorithm

Pursuant to some embodiments, the content segmentation process 260 (FIG. 2) divides content into manageable units (content segments 270) for processing and presentation. Pursuant to some embodiments, the segmentation algorithm operates according to the following rules: segment lengths should fit within a configured range defined by minimum and maximum character counts; among multiple candidate sentence boundaries, the algorithm prioritizes paragraph endings (that end with a newline) and then endings nearer to a target length corresponding to the midpoint of the configured range; sentences too long to fit within the maximum are allowed to overflow in the absence of a better split point; and if the last segment is too short, it is merged with the penultimate segment.

Pursuant to some embodiments, content can be split into sentences using an NLP library or string processing tools. If the text lacks punctuation, a pre-processing step is applied to add punctuation (e.g., using NLP or LLM models), or the learning platform 120 falls back to LLM-based segmentation. In some embodiments, it can be desirable to split to segments based on sentence endings, and to prefer paragraph endings. This helps to ensure that the subsequent processing works on a complete input and has the proper context. In some embodiments, the content may be split into segments with overlap at the beginning and the ending of the segment. The overlap provides additional context to the subsequent processors in the pipeline, and can be dropped from the subsequent segments (after processing) to avoid duplication in the output audio.

Pursuant to some embodiments, the learning platform 120 applies an optimization where it does not generate the audio for the entire content at once, because the learning platform 120 does not know in advance how much content the user will consume. However, when presenting content to the user, the learning platform 120 provides estimates of how long consumption will take. The system uses estimation logic that, given a text, estimates the total duration of the audio output based on metrics such as character count, token count, or word count, taking into account that different languages have different statistical properties. This is particularly useful in situations where the learning platform 120 has few (or no) segments processed (e.g., at the start of a content session). At the start, the learning platform 120 does not yet know the actual duration of the final audio output, but the estimates allow an improved user experience. For example, even though the learning platform 120 does not yet know the full duration of the audio to be output, having an estimate allows enough of the text to be displayed to the user to allow the user to scroll through the content (even though the audio processing may not yet be complete). The estimates may include an estimate of the length of both the original and the translated audio and may include inputs such as the language, the translated language, the cadence and pace of the speaker, the proficiency, and the text itself. These estimates enable the user to navigate within the content (e.g., by scrolling or jumping to a particular position) in a user interface (such as the user interface 550 of FIG. 5D).

Pursuant to some embodiments, the learning platform 120 applies an on-demand segment processing optimization to reduce computational cost while maintaining responsiveness. The first segment that is processed is generally shorter than subsequent segments and is generated a priori to ensure it is readily available for immediate consumption by the learner. Subsequent segments may be generated on request from the frontend 410 and may, for example, be initiated shortly before the current played segment completes. If the learner skips ahead in the content (e.g., by fast-forwarding), the next segment to be played may be split into a “header” portion and a “remainder” portion, where the header is expedited for immediate audio generation to reduce the learner's wait time.

### Chunking Algorithm

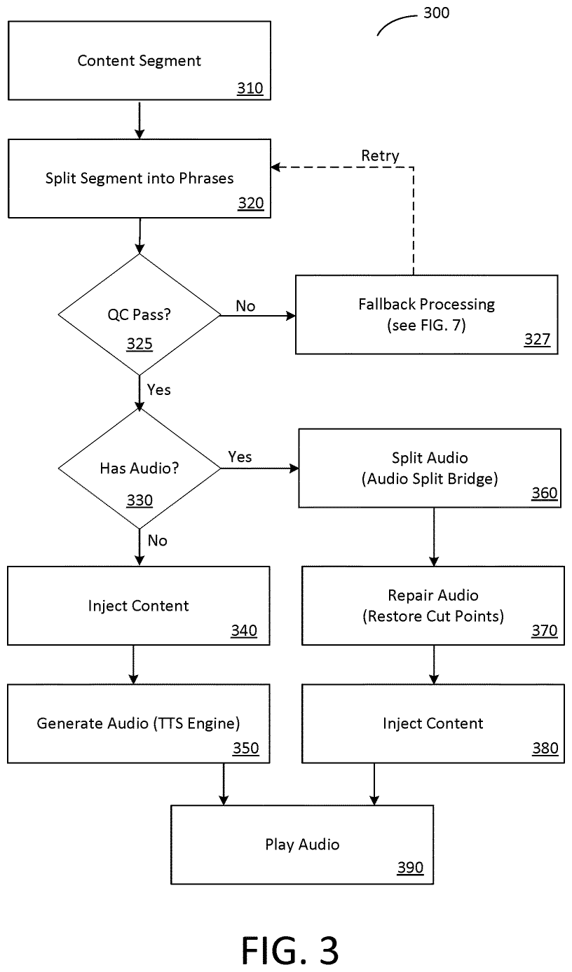

Pursuant to some embodiments, as shown in the split segment into phrases process 320 of FIG. 3, each content segment 310 is further divided into smaller units called “chunks” or “phrases.” The chunking algorithm splits content into phrases while preserving natural language boundaries (e.g., pauses at commas, colons, periods, and similar punctuation) and content semantics (i.e., without impacting the meaning of the text). The target average phrase length is determined based on metadata related to the learner, such that more beginner users receive shorter chunks and more advanced users receive longer ones. Further details of the chunking and segmentation will be provided below in conjunction with a more detailed description of FIG. 3.

Pursuant to some embodiments, the splitter module 170 (FIG. 1B) relies primarily on NLP-based approaches for chunking. The NLP-based chunking algorithm takes into account part-of-speech tags (which help identify word roles and relations), dependency parsing (which considers structural relations), and constituency trees (which identify natural phrase boundaries). This NLP-based approach accounts for the grammatical structure of the language, including which words must appear adjacent to other words (e.g., compound words like “ice cream” should not be split) and the role of punctuation. This provides a more deterministic and linguistically grounded approach compared to purely LLM-based chunking.

Pursuant to some embodiments, alternative chunking approaches may also be used. In a basic LLM-based approach, the foreign language content is split into phrases using an LLM prompt that is provided with context including the learner's proficiency and target phrase length, and each resulting foreign language phrase is then translated to the native language using a separate LLM prompt. In a more advanced LLM-based approach, the content is first split into sentences (e.g., programmatically or via LLM), each sentence is translated, and then each sentence is further split into chunks of words according to special marker tags (e.g., delimiter tags placed around phrase groups). For marked chunks, the chunk is retranslated separately; for unmarked chunks, the LLM splits the sentence in one language into sub-phrases, translates each sub-phrase, and matches translated chunks to original chunks. These LLM-based approaches may serve as alternatives or fallbacks to the NLP-based chunking described above.

### NLP-Based Chunking Algorithm

Pursuant to some embodiments, the splitter module 170 (FIG. 1B) implements an NLP-based chunking algorithm that splits content into syntactically coherent phrases sized to a language learner's proficiency level. The algorithm proceeds through four stages: NLP analysis, constraint extraction, distribution selection, and post-processing. The target phrase size is determined by the learner's proficiency level (e.g., as indicated by a standardized proficiency framework such as CEFR or as otherwise determined as described herein), such that beginner learners receive short phrases (e.g., two or three words) while advanced learners receive longer phrases that may span entire clauses or sentences.

Applicant has found that naïve algorithms that cut text at fixed word intervals routinely break apart grammatical units that belong together, such as separating a determiner from its noun, a verb from its particle, or a number from the noun it modifies, producing unnatural phrases that are harder for both the learner and downstream translation steps. The NLP-based chunking algorithm addresses this by using full syntactic analysis of the source text to identify which words must stay together, and by using knowledge of both the source and target language grammars to place phrase boundaries at structurally meaningful positions.

### Stage 1: NLP Analysis

In the NLP analysis stage, the content text is processed using NLP tools (e.g., a syntactic parsing pipeline) to produce, for each word, linguistic annotations including a word identifier, a part-of-speech (POS) tag, a dependency relation label, a head identifier indicating the word's syntactic governor, and character-offset information. These annotations provide the structural foundation for the subsequent stages.

### Stage 2: Constraint Extraction

In the constraint extraction stage, the algorithm extracts two types of information for each sentence: must-stay-together pairs and verb/copula frames. A must-stay-together pair designates two words that must remain in the same phrase. After all pairs are collected, they are merged into contiguous indivisible groups (e.g., if words 3-4 and 4-6 must each stay together, the entire span 3-6 becomes one group).

The algorithm identifies several categories of must-stay-together constraints, including: multi-word tokens (e.g., French “du” expanding to “de”+“le”); absolute syntactic dependency constraints where the dependent and its head must always stay together (e.g., compound words, case markers, classifiers, expletive subjects, multi-word expressions, named entities, numeric and adjectival modifiers, and verb particles); conditional syntactic dependency constraints where the dependent and head are kept together only when they are within a configurable distance (e.g., nominal modifiers and subordinating conjunctions, which may legitimately be split at higher proficiency levels when they would cause a phrase to exceed the maximum length); symbol sequence constraints for consecutive runs of symbols or numbers (e.g., “§ 3.2,” “100,000”); compound marker constraints for words joined by apostrophes, hyphens, or underscores (verified by character offsets); and punctuation attachment constraints that prevent isolated punctuation by attaching each punctuation token to its nearest non-punctuation word (with opening brackets attaching to the right).

The constraint extraction stage also accounts for language-specific phenomena. For example, in Romance languages and others that exhibit clitic climbing (where object pronouns attach phonologically to a verb other than their syntactic head), the algorithm keeps object pronouns with their current syntactic head. For languages with null copulas (e.g., Russian, Arabic, Hebrew, Turkish, Chinese), where the verb “to be” may be omitted, any detected copula token is kept with its predicate head. Additional language-specific profiles may be added as more languages are supported.

The constraint extraction stage also extracts verb and copula frames representing the grammatical backbone of each sentence. A verb frame identifies Subject, Verb, Object, and Auxiliary roles, while a copula frame identifies Subject, Copula, and Predicate roles. Frames are extracted through multiple passes over the sentence and are retained only when sufficient structure exists (e.g., at least a subject or object) to guide phrase splitting. A complex sentence may yield multiple frames.

### Stage 3: Distribution Selection (Word-Order-Aware Chunking)

When verb or copula frames are found, the distribution selection stage determines phrase boundaries by consulting the word order typology of both the source and target languages. Languages differ in their canonical Subject-Verb-Object ordering (e.g., SVO, SOV, VSO, V2-Full, or free order), and a phrase boundary placed incorrectly for a given typology (e.g., between a verb and its object in a VSO language) may create fragments with no clean equivalent in the target language. Given the source and target word orders, the algorithm retrieves accepted chunk structure templates that specify where grammatical anchors are placed.

Because sentences contain many words beyond the grammatical anchors, the algorithm expands each template by resolving anchors to word spans, merging with must-stay-together groups, and distributing remaining words to phrases based on their syntactic head relationships. Words between anchors are attached to the phrase containing their syntactic head where possible, with preferred punctuation boundaries (e.g., commas, semicolons) used as tiebreakers. Undersized phrases are merged into neighbors. Each candidate distribution is scored based on how closely its phrase sizes match the target size window, and the best-scoring distribution is selected. Candidates that would violate must-stay-together constraints or exceed the maximum phrase length are filtered out.

When a sentence has no detectable verb or copula frames (e.g., headings, sentence fragments, lists), the algorithm falls back to a greedy chunking approach that walks left to right, absorbing must-stay-together groups, flushing phrases at natural punctuation break points when the minimum size is met, and starting new phrases when the maximum size would be exceeded.

### Stage 4: Post-Processing

After all sentences are chunked, post-processing cleanup passes merge punctuation-only phrases into neighbors and adjust boundary punctuation so that opening brackets or quotes are moved to the beginning of the phrase they logically introduce, and closing brackets or quotes are moved to the end of the phrase they logically close.

### LLM-Based Chunking

Pursuant to some embodiments, as an alternative or complement to the NLP-based chunking algorithm, the splitter module 170 may employ an LLM-based chunking approach that delegates the chunking task to a large language model. The prompt is designed to specify only what the LLM cannot infer from its own linguistic knowledge: the output encoding format, content-word counting rules, phrase size bounds derived from the learner's proficiency level, punctuation attachment direction, and a translatability constraint. Detailed must-stay-together categories are deliberately omitted from the prompt, instead relying on a single instruction to keep syntactic constituents intact.

The raw LLM output is passed through a validation and repair pipeline that detects and classifies formatting issues as repairable (e.g., missing or malformed delimiters, partial markers, minor trapped text) or irreparable (e.g., substantive content outside phrase boundaries, empty phrases, phrase count mismatches). Repairable issues are corrected automatically; irreparable issues trigger fallback to a different LLM model or to the NLP-based chunking algorithm. A source realignment step then corrects any whitespace substitutions by matching phrase content against the original source text to restore exact character-offset correspondence.

### Chunk-Faithful Translation

Pursuant to some embodiments, the translate module 168 (FIG. 1B) implements a chunk-faithful translation operator that translates pre-chunked content while preserving the exact chunk structure: each source phrase maps to exactly one translated phrase at the same index, with no merging, splitting, or reordering permitted. This one-to-one structural fidelity takes priority over idiomatic naturalness in the target language, because the phrase boundaries encode meaningful units optimized for the learner's proficiency level.

The operator is governed by several linguistic trade-offs. For language pairs with significantly different constituent orders (e.g., English SVO to German SOV), the operator may produce phrase-aligned output that is grammatically non-standard in the target language in order to preserve structural correspondence. Multi-word expressions spanning phrase boundaries in the source are distributed across the corresponding translated phrases rather than collapsed. The operator also employs an intra-sentence context awareness step in which each translated phrase is reviewed against its surrounding phrases to maintain coherence across the sentence.

The chunk-faithful translation operator applies a multi-stage validation and repair pipeline to the LLM output. Repairable issues (e.g., missing or malformed delimiters, index mismatches, minor trapped garbage) are corrected automatically and logged as warnings. Irreparable issues (e.g., substantive trapped text, empty phrases, phrase count mismatches) are logged as errors and trigger fallback processing as described in the quality control and fallback hierarchy flow 700 (FIG. 7). The pipeline employs an escaped-marker hiding technique that replaces escaped delimiter characters with temporary sentinel characters before structural parsing, preventing literal content from being misidentified as phrase boundaries.

### Combined Single-Pass Chunking and Translation

Pursuant to some embodiments, the learning platform 120 implements a combined operator that performs chunking and translation simultaneously in a single LLM call, producing paired source and translated phrases sharing the same indices. The single-pass design reduces latency and keeps chunking and translation decisions mutually informed. The prompt frames the model in a pedagogical role and specifies phrase size bounds, a syntactic cohesion principle (keeping noun phrases, verb phrases, prepositional phrases, compounds, and grammatical particles intact), punctuation attachment rules, a verbatim source copying requirement, and whitespace rules ensuring consistency between paired phrases. The same validation and repair pipeline is applied to the combined operator's output.

### Translation and Proficiency-Level Adaptation Modes

Pursuant to some embodiments, the adapt module 164 and the translate module 168 (FIG. 1B) may be implemented as a modular operator supporting three modes: a translation-only mode that translates without proficiency-level adaptation; an adaptation-only mode that rewrites text for a target proficiency level without translating (e.g., simplifying an advanced text for an intermediate learner); and a translation-with-conditional-adaptation mode that translates and applies adaptation only when the translated text exceeds the target proficiency level in complexity.

All three modes preserve the original intent, tone, and stylistic features of the source, rendering cultural references and idioms with equivalent effect rather than literally. A unidirectional simplification constraint ensures that text already at or below the target level is not made more complex. For beginner and lower-intermediate learners, the operator implements cognate priming by preferentially selecting target-language words that are recognizable cognates of the learner's native language, lowering cognitive load. In all modes, the operator produces only the processed text as output, with no commentary or extraneous formatting.

### Quality Evaluation Framework for Content Processing Operators

Pursuant to some embodiments, the quality control module 180 (FIG. 1B) implements evaluation metrics applied to the outputs of the chunking, translation, adaptation, and combined operators. The metrics may be used for online quality control (within the fallback hierarchy flow 700 of FIG. 7), offline quality control 792, or both. For the chunking operators, syntactic checks verify that the output format is correct, that all source content is preserved, and that phrase sizes fall within the target range, while semantic checks verify that compound words and syntactic constituents are not improperly split. For the translation and adaptation operators, syntactic checks verify output format and that markers are retained, while semantic checks verify structural correspondence and meaning preservation.

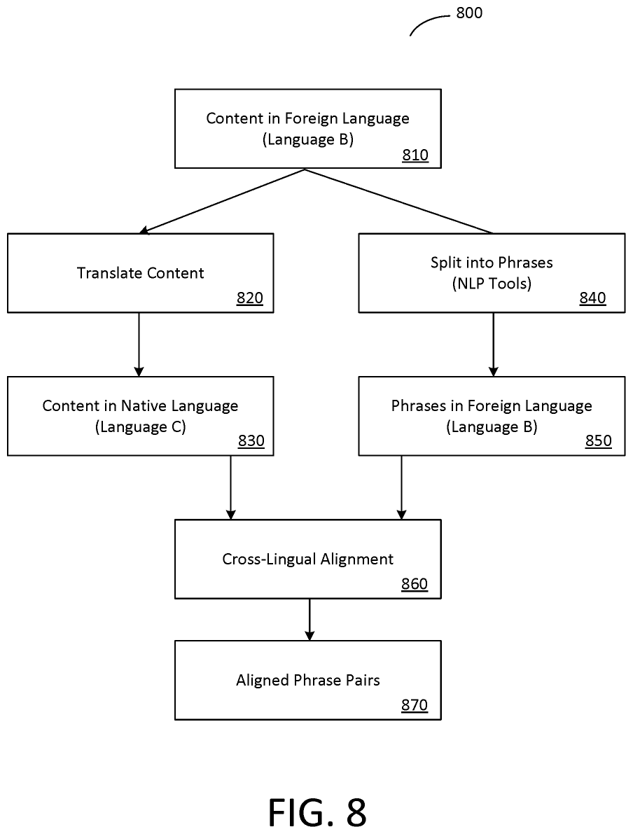

The chunking and translation operators described herein may be employed within any of the translation and phrase alignment approaches described below in conjunction with FIGS. 8-10.

### Hybrid NLP/LLM Processing and Quality Control

Pursuant to some embodiments, the learning platform 120 combines NLP and LLM models to perform content processing tasks, including translation, adaptation, modification, and chunking. NLP processing tends to be computationally expensive in terms of cost (and often requiring GPUs) but it does not involve third party LLM services and their associated per-request latency and per-token cost. The learning platform 120 employs a hybrid approach that leverages the strengths of each technique. For example, in some situations, the learning platform 120 may dynamically (e.g., based on the language, the user, the content, etc.) choose a particular combination of NLP and LLM (and different LLMs) to achieve a desired outcome. For example, a particular LLM may be better suited to a certain language, or a certain type of text. By dynamically selecting among different NLP and LLMs cost, performance and accuracy can be improved for different situations.

The outputs of NLP components and LLMs are not always precise or correct. LLMs are inherently non-deterministic and often inconsistent. Given that the resulting audio is intended for language learning, strict quality standards are required. NLP components may be used to assess the quality of LLM outputs.

To address this, some embodiments utilize a quality control module 176 (FIG. 1B) that implements a two-tier quality control framework as shown in FIG. 7. The quality control and fallback hierarchy flow 700 begins with a processing task output 710 from the NLP or LLM processing modules. The output first undergoes a syntactic quality check 720, which includes formatting validation (verifying the structural format of the output), delimiter/marker validation (verifying that delimiters and trace markers are correctly placed), and length/count validation (verifying character, word, token, and punctuation counts). The output then undergoes a semantic quality check 730, which includes, for example, a parts-of-speech comparison (NLP-based analysis comparing verbs, nouns, and their relations) and a meaning preservation query (LLM-based queries for the specific quality measure in question).

The quality control and fallback hierarchy flow 700 (FIG. 7) employs two sequential decision gates. After the syntactic quality check 720, a syntactic pass decision 742 determines whether the output is structurally correct. If the output passes the syntactic pass decision 742, the flow proceeds to the semantic quality check 730, followed by a semantic pass decision 744. If the output passes the semantic pass decision 744, a validated output 790 is produced for further processing. If the output fails the syntactic pass decision 742, structural remediation 750 attempts to correct common, predictable formatting errors (e.g., a missing bracket or delimiter that are not uncommon with LLM output). The remediated output is then re-evaluated at the syntactic pass decision 742. If structural remediation is insufficient to pass the syntactic pass decision 742, or if the output passes the syntactic pass decision 742 but subsequently fails the semantic pass decision 744, the system employs a cascading series of fallback methods. A retry with adapted prompt 760 (agentic mode) re-submits the task to the same model with a modified prompt. If that is unsuccessful, a retry with a stronger/different LLM model 770 escalates to a more capable but potentially more expensive model. If all LLM-based fallbacks are unsuccessful, the system performs a fallback to deterministic NLP processing 780, which is more reliable but may require more processing time.

In addition to the online quality control pipeline described above, in some embodiments, an offline quality control 792 may be performed to conduct computationally intensive analyses on sampled outputs, enabling detailed checks for linguistic accuracy, coherence, and comprehension. The offline quality control 792 results may be used to tune the thresholds and parameters of the online quality control pipeline. Further, in addition to the fallback approaches described above, other fallback approaches may be added. For example, agentic approaches with LLMs may provide additional fallback options. In some embodiments, one or more digital signal processors (DSPs) may be used to assess the quality of the outputs. For example, a DSP may be used to measure or determine the length of an audio or audio segment to determine whether differences between the input content and the output audio exist (which may indicate an issue in the pipeline).

### Quality Evaluation Metrics for Content Processing Operators

Pursuant to some embodiments, the quality control module 180 (FIG. 1B) implements a suite of evaluation metrics that are applied to the outputs of the content processing operators of the learning platform 120, including the chunking operators (e.g., the NLP-based chunking algorithm, the LLM-based chunking algorithm, and the combined single-pass chunking and translation operator), the chunk-faithful translation operator, and the translation and adaptation operators. The evaluation metrics may be used in the online quality control pipeline (within the quality control and fallback hierarchy flow 700 of FIG. 7) for real-time detection and correction of errors prior to content delivery, in the offline quality control 792 for computationally intensive analysis of sampled outputs, or in both contexts depending on the metric's computational requirements. The evaluation metrics are organized by the type of processing operator whose output is being evaluated: chunking quality metrics, chunk translation quality metrics, and translation and adaptation quality metrics.

### Chunking Quality Metrics

### Phrase Size Range Compliance Metric

Pursuant to some embodiments, a phrase size range compliance metric evaluates whether the phrases produced by a chunking operator violate the target proficiency-level word-count range and, if so, quantifies the magnitude of the deviation. The metric operates as follows. First, the target minimum and maximum content-word counts are determined from a proficiency-level range configuration (e.g., a lookup table mapping each proficiency level, such as CEFR levels A1 through C2, to a minimum and maximum number of content words per phrase). Second, the phrases are extracted from the output of the chunking operator. Third, phrases that contain no alphanumeric characters are excluded from evaluation, as such phrases (e.g., punctuation-only phrases) are evaluated by a separate structural validity metric. Fourth, for each remaining phrase, the number of content words is counted, excluding punctuation tokens. If the content-word count falls outside the target range, the metric computes the deviation as the difference between the content-word count and the nearest boundary of the target range.

For the combined single-pass chunking and translation operator, only the source-language phrases are evaluated by this metric, because the source phrases define the reading-unit boundaries for the learner. The translated phrases are not evaluated for size range compliance, as translation may naturally expand or contract phrase length relative to the source language. This metric may be used for both online evaluation (within the real-time processing pipeline) and offline evaluation (as part of a sampled quality analysis).

### Syntactic Dependency Integrity Metric

Pursuant to some embodiments, a syntactic dependency integrity metric evaluates how well a chunking operator respects syntactic dependency boundaries. Dependency relations are part of dependency parsing, a syntactic analysis framework (e.g., the Universal Dependencies framework) that represents the structure of a sentence as a set of head-dependent relations between words. Each word in a sentence (except the root) has exactly one head, and the relation between the dependent word and its head is labeled with a grammatical role (e.g., subject, object, modifier, determiner, compound, and the like). The syntactic dependency integrity metric evaluates whether the chunking operator has kept syntactically related words together within the same phrase or has improperly separated them across phrase boundaries.

In some embodiments, the syntactic dependency integrity metric produces two complementary scores. A first score, referred to as an integrity score, measures across all dependency pairs in the content what fraction of pairs has both the dependent word and its head word in the same phrase. A second score, referred to as a must-stay score, performs the same calculation but restricted to the subset of dependency types that the chunking operator's splitting rules designate as must-stay-together pairs (e.g., compounds, determiners, particles, case markers, named entities, and similar relations as described above). The must-stay score is a more targeted and actionable measure, because a low must-stay score indicates that the chunking operator is breaking apart word pairs that its own constraint rules require to remain together.

Pursuant to some embodiments, the metric is computed as follows. First, a full NLP parsing pipeline (including tokenization, multi-word token expansion, part-of-speech tagging, lemmatization, and dependency parsing) is run on the concatenated phrase text in the source language. Second, character-offset boundaries are constructed for each phrase. Third, for each word in the parsed output (excluding the root node), the word and its head are each mapped to a phrase index using the character-offset boundaries. For words that arise from multi-word token expansion and lack their own character offsets, the algorithm falls back to the parent token's character offset. Fourth, the integrity score is computed as the number of dependency pairs where the dependent and head share the same phrase, divided by the total number of non-root dependency pairs, expressed as a percentage. Fifth, the must-stay score is computed using the same formula but restricted to pairs whose dependency relation label is in the set of must-stay-together dependency types or whose universal part-of-speech tag indicates a particle. The metric emits the total dependency pair count, the integrity percentage, the must-stay pair count, and the must-stay integrity percentage. This metric is primarily used for offline quality evaluation.

### Structural Validity and Reconstructability Metric

Pursuant to some embodiments, a structural validity metric evaluates whether the output of a chunking operator is structurally valid, meaning that the output is both reconstructable and free of empty or non-textual phrases. The metric operates as follows. First, the encoded phrase output from the chunking operator is decoded back into a list of phrase strings. Second, a reconstructability check is performed by concatenating all phrase strings and comparing the result to the original source text. If the concatenated phrases do not exactly match the source text, a recombine-mismatch error is reported and no further checks are performed, because a failure of reconstructability indicates that the chunking operator has lost, added, or altered content, which is a fundamental error. Third, if reconstructability passes, each individual phrase is checked for the presence of at least one alphanumeric character. Any phrase that contains no alphanumeric characters (e.g., a phrase consisting only of punctuation or symbols) is flagged as an error. This metric may be used for both online and offline evaluation.

### Chunk Translation Quality Metrics

### Semantic Alignment via Multilingual Sentence Embeddings

Pursuant to some embodiments, a semantic alignment metric evaluates whether each translated phrase is semantically aligned with its corresponding source-language phrase—that is, whether the translated phrase is a plausible translation of the source phrase. The metric uses multilingual sentence embedding models to achieve cross-lingual semantic comparison in a scalable and fully automated manner. A multilingual sentence embedding model maps text from multiple languages into a shared vector space in which semantically equivalent texts in different languages are represented by vectors that are close together (e.g., as measured by cosine similarity or Euclidean distance). For each source-translated phrase pair, the metric computes the embedding of the source phrase and the embedding of the translated phrase using the multilingual model, and then computes a similarity score between the two embeddings. A similarity score below a configurable threshold indicates a potential semantic misalignment, meaning the translation may not accurately convey the meaning of the source phrase. This metric may be used for both online evaluation (for real-time detection of translation errors) and offline evaluation (for systematic quality analysis of sampled outputs).

### Structural Validity of Translated Phrases

Pursuant to some embodiments, a structural validity metric for translated phrases evaluates whether the translated output maintains structural correspondence with the source phrases and whether each translated phrase is plausibly sized relative to its source counterpart. The metric performs the following checks. First, a chunk count check verifies that the number of source phrases equals the number of translated phrases. A mismatch indicates that the translation operator has merged, split, or dropped phrases, violating the one-to-one structural fidelity constraint. Second, a chunk index check verifies that the set of phrase indices in the translated output matches the set of phrase indices in the source output. A mismatch indicates index corruption or reordering. Third, each translated phrase is checked for the presence of at least one alphanumeric character; a translated phrase with no alphanumeric content is flagged as an invalid phrase.

Fourth, a word-count ratio check is performed for each source-translated phrase pair. Using language-aware word counting (which accounts for differences in how languages segment words, e.g., agglutinative languages may produce fewer but longer tokens than analytic languages), the metric computes the ratio of content words in the translated phrase to content words in the source phrase. If the ratio deviates from an expected range by more than a configurable threshold (e.g., a deviation of more than fifty percent), the phrase pair is flagged for review as potentially containing a translation error such as an untranslated phrase, an excessively verbose translation, or a significant omission. The structural checks may be used for both online and offline evaluation, while the word-count ratio check is primarily used for offline evaluation.

### LLM-Based Translation Quality Review

Pursuant to some embodiments, an LLM-based translation quality review metric provides an assessment of chunk translation quality using an LLM-as-a-judge methodology. In this approach, the source phrases and their corresponding translated phrases are sent to a dedicated language model together with a set of review instructions. The language model is instructed to evaluate the accuracy of each translated phrase relative to its source and to quantify the translation quality in a measurable and unambiguous manner. The evaluation output includes a numeric quality score (e.g., a translation quality rating on a scale from one to ten) and a binary pass/fail flag designed to identify unacceptable translation issues (e.g., semantic inversion, untranslated content, hallucinated content, or critical omissions). The numeric score provides a graded assessment of translation quality, while the pass/fail flag provides a coarse-grained signal suitable for triggering fallback processing. This metric is primarily used for offline evaluation, although the pass/fail flag may also be used at runtime for online evaluation to trigger fallback processing within the quality control and fallback hierarchy flow 700 (FIG. 7).

### Translation and Adaptation Quality Metrics

### LLM-Based Proficiency-Level Evaluation

Pursuant to some embodiments, an LLM-based proficiency-level evaluation metric assesses whether the output of a translation or adaptation operator matches the target proficiency level of the learner, capturing nuanced linguistic quality dimensions that rule-based metrics cannot easily measure. The metric operates as follows. First, if the result is in an encoded phrase format, the phrases are joined into plain text for evaluation. Second, a system prompt is constructed dynamically from a configuration associated with the target proficiency level (e.g., a proficiency level such as A1, A2, B1, B2, C1, or C2). For beginner and lower-intermediate levels (e.g., A1 through B1), the prompt may include additional instructions that emphasize stronger simplification requirements. Third, the constructed prompt, together with the source and target language identifiers and the text to be evaluated, is submitted to a language model.

The language model returns a structured evaluation comprising scores across multiple linguistic dimensions. Pursuant to some embodiments, the evaluation dimensions may include a vocabulary score evaluating whether the word choices are appropriate for the target proficiency level (e.g., whether high-frequency, level-appropriate vocabulary is used and whether overly complex or rare words are avoided at lower levels). The evaluation dimensions may also include a syntax score evaluating whether the sentence structures are appropriate for the target level (e.g., whether sentence length and nesting complexity match expectations) and a grammar score evaluating whether the grammatical constructs are appropriate (e.g., whether verb tenses, moods, and clause types match the target level). The evaluation dimensions may also include a cohesion score evaluating whether the text flows naturally with appropriate use of conjunctions, transitions, and discourse markers for the target level and a register score evaluating whether the tone and formality are appropriate. In some embodiments, each dimension is scored on a numeric scale (e.g., zero to three, where zero indicates a poor match and three indicates a perfect match for the target level). An overall score is computed as the arithmetic mean of the individual dimension scores. The language model may also produce a qualitative commentary field providing natural-language explanations of any identified issues. This metric is primarily used for offline evaluation.

### NLP-Based Proficiency-Level Evaluation

Pursuant to some embodiments, an NLP-based proficiency-level evaluation metric provides a deterministic assessment of whether the output of a translation or adaptation operator exhibits structural and syntactic complexity consistent with the target proficiency level, using NLP tooling rather than a language model. This metric complements the LLM-based proficiency-level evaluation by providing a reproducible, deterministic measurement that does not depend on the non-deterministic behavior of language models.

The metric may operate as follows. First, the text is parsed using an NLP pipeline that performs tokenization, part-of-speech tagging, lemmatization, and dependency parsing. Second, for each sentence, a set of raw structural statistics is collected, including, for example, a sentence length measured in content words (excluding punctuation tokens), a dependency tree depth computed for each token by walking the dependency chain from the token to the root node, a verb count, auxiliary verb count, conjunction count, and subordinate clause count, and the ratio of main clauses to subordinate clauses. Third, each statistic is compared against a proficiency-level range table that specifies expected ranges for each statistic at each proficiency level (e.g., proficiency levels A1 through C2). A scoring function evaluates each statistic against the expected range, producing a score on a scale (e.g., a three-level scale of poor, acceptable, or perfect match), with linear interpolation applied for values that fall near the boundaries of the expected range.

Fourth, the individual statistic scores are grouped into composite dimensions. Pursuant to some embodiments, the composite dimensions may include a sentence length dimension computed as the mean of the average sentence length score and the maximum sentence length score, a syntax dimension computed as the mean of the average dependency tree depth score and the maximum dependency tree depth score, a grammar dimension computed as the mean of the clause ratio score, verb count score, auxiliary verb count score, and subordinate clause count score, and a cohesion dimension based on the conjunction-per-sentence rate. The overall score is computed as the arithmetic mean of the composite dimension scores. This metric is primarily used for offline evaluation, and the results of the offline evaluation may be used to tune the parameters and thresholds of the online quality control pipeline, as described above with reference to the offline quality control 792 of FIG. 7.

### Translation Semantic Evaluation

Pursuant to some embodiments, translation quality for the simple translation operator and the translation-with-conditional-adaptation operator is evaluated using the same multilingual sentence embedding approach and LLM-as-a-judge methodology described above with reference to the chunk translation quality metrics, applied at the full-text level rather than the phrase level. In the embedding-based approach, the complete source text and the complete translated text are each mapped to a multilingual embedding vector, and their semantic similarity is computed. In the LLM-as-a-judge approach, the source and translated texts are submitted to a language model with instructions to evaluate translation accuracy, meaning preservation, and fluency, producing both a numeric quality score and a pass/fail determination. These metrics may be used for both online and offline evaluation.

### Translation and Phrase Alignment

Pursuant to some embodiments, the phrase splitting may also include reordering words within a phrase. Because some languages order words differently than others, the translated phrase may require word reordering to maintain comprehension while preserving context. This is a non-trivial task, and the learning platform 120 may employ sophisticated heuristics or AI processing to accomplish it. The learning platform 120 uses full-sentence context to ensure the correct meaning is translated across small phrase boundaries (e.g., the word “nail” as “fingernail” vs. “hammer a nail”). Pursuant to some embodiments, the translate module 168 (FIG. 1B) of the learning platform 120 performs translation processing to translate content between languages. The learning platform 120 supports multiple approaches to translation and phrase alignment, illustrated in FIGS. 8-10. In the descriptions below, Language B refers to the foreign language (the language being learned) and Language C refers to the native language of the learner.

A first approach is shown in FIG. 8, where an NLP chunking and cross-lingual alignment process 800 is shown. In this process 800, content in the foreign language 810 is translated using machine translation (MT) or an LLM at 820 to produce content in the native language 830. The content in the foreign language is split into phrases using NLP tools at 840 to produce phrases in the foreign language 850. A cross-lingual alignment 860 aligns the foreign language phrases with matching phrases in the translated native language content to produce aligned phrase pairs 870. In this approach, translation is independent of the split-to-phrases step, providing flexibility in choosing the translation engine. However, it depends on a cross-lingual alignment model.

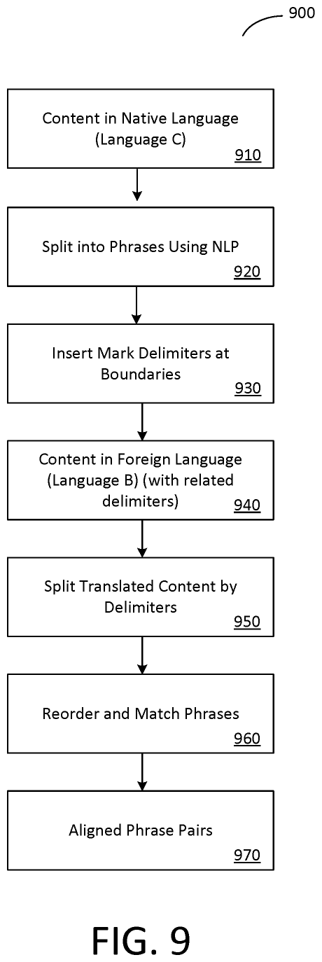

In a second approach shown in FIG. 9. A process 900 is shown which utilizes NLP chunking with delimiter-based translation. Process 900 splits content in the native language 910 into phrases using NLP tools at 920. Mark delimiters are inserted into the content at 930 at positions corresponding to the phrase boundaries. The marked content is translated using MT or an LLM, which retains the delimiters, producing content in the foreign language with retained delimiters 940. The translated content is then split by the delimiters at 950, and the phrases are reordered and matched at 960 to produce aligned phrase pairs 970. This approach does not require complex alignment mechanisms and relies on the translation model to retain trace markers, eliminating the issue of retaining context in each phrase.

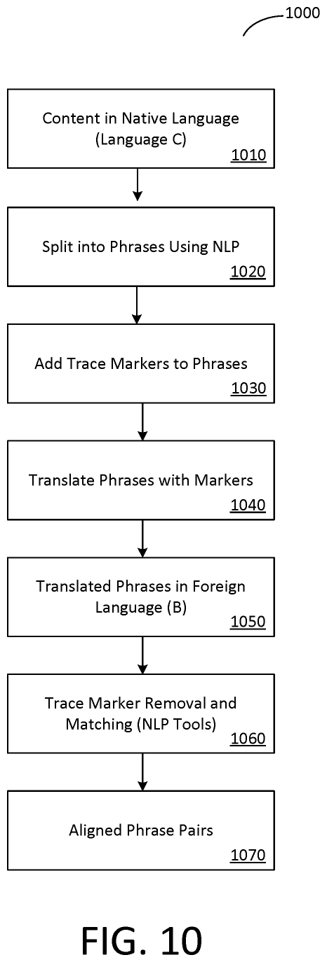

A third approach is shown in FIG. 10, where an NLP chunking with trace marker translation process 1000 is illustrated. In this process 1000, content in the native language 1010 is split into phrases using NLP tools at 1020. Trace markers are added to the resulting phrases at 1030. The marked phrases are translated using MT or an LLM at 1040, producing translated phrases with trace markers 1050. A trace marker removal and phrase matching step 1060 using NLP tools arranges and matches the phrases between languages to produce aligned phrase pairs 1070. This combines the linguistic precision of NLP-based chunking with the context preservation of trace-marker-based translation.

Pursuant to some embodiments, the quality of translation outputs is verified using the quality control module 180 and the quality control and fallback hierarchy flow 700 (FIG. 7), including both syntactic validation and semantic validation as described above.

### Partial Translation and Personalized Familiarity

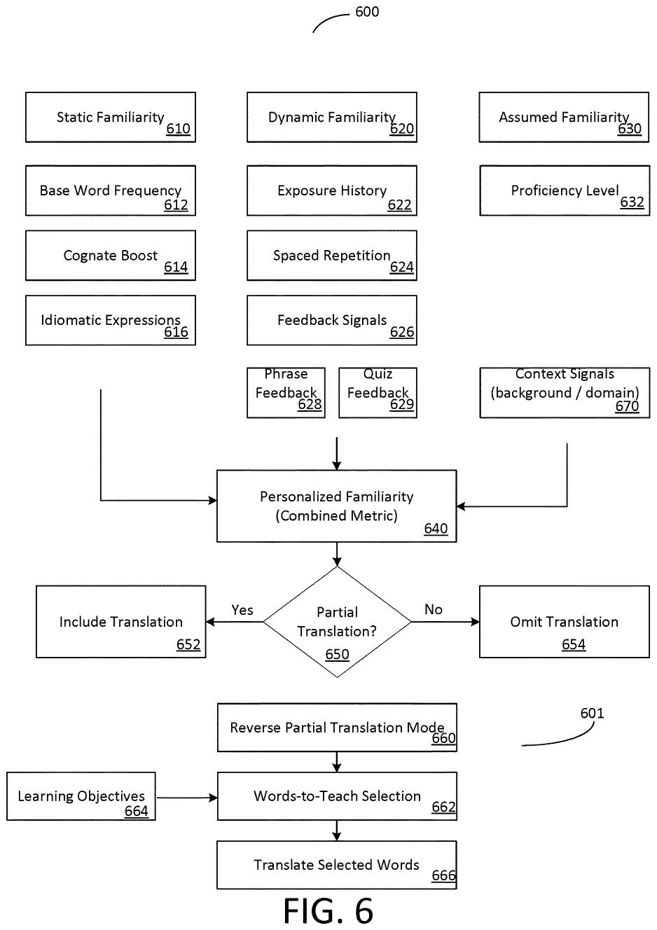

Pursuant to some embodiments, the system implements partial translation to improve the learning experience, as shown in a personalized familiarity and partial translation flow 600 of FIG. 6. The primary use of partial translation is to skip the translation for words and phrases that are predicted or expected to be understood by the user, thereby reducing interruptions and allowing the learner to consume content more naturally.

Pursuant to some embodiments, the learning platform 120 supports multiple use cases for partial translation. In a first use case, targeting non-beginner users, the learning platform 120 uses the partial translation decision 650 (from FIG. 6) to determine whether to include translation 652 or omit translation 654 for each word or phrase. The written translation may still be displayed on-screen per the user's preference. This approach has an additional benefit of reducing operational costs by skipping audio generation for understood content.

In some embodiments, the learning platform 120 implements a reverse partial translation mode 660 for beginner-level learners. In reverse partial translation, the system plays the native language in full and selectively translates only selected parts into the foreign language. A words-to-teach selection 662 receives input from learning objectives/lesson plan input 664 to determine which words and phrases to translate into the foreign language. Beginner learners typically start with little or no prior knowledge of the foreign language, and the language needs to be introduced gradually. Other teaching methods introduce vocabulary and grammar based on a predetermined syllabus that often relies on very basic, artificially constructed phrases. Using real-world content as the basis for instruction helps engage the learner with how language is used in everyday contexts, but at the beginning, learners lack enough knowledge to engage effectively with authentic materials. Reverse partial translation solves this by selecting content parts suitable for building a foundation, depending on the learner's level and progress.

As a result, in some embodiments, partial translation identifies known words, or words expected to be understood from context or otherwise, as candidates to be omitted from audio and/or translation into the native language (omit translation path 654), supporting efficient content consumption for non-beginners. Reverse partial translation mode 660 identifies unknown words or words to teach as candidates to be included in audio and/or translation into the foreign language (via the words-to-teach selection 662), supporting gradual foundational teaching for beginners.

As shown in FIG. 6, partial translation decisions rely on a personalized familiarity metric 640 that models how familiar a learner is with each word in their learning language. Pursuant to some embodiments, the personalized familiarity metric 640 is computed based on three factors: a static familiarity computation 610, a dynamic familiarity computation 620, and an assumed familiarity computation 630.

Pursuant to some embodiments, a static familiarity computation 610 measures how common a word is in the learning language and how closely it resembles a word in the learner's native language. Static familiarity can be computed on-demand when new content is processed and may be derived, pursuant to some embodiments, from the following inputs: a base word frequency input 612, representing the word's absolute frequency in the foreign language (e.g., when learning Italian at level B1, it is likely that the word “casa” is known even though it has not yet appeared in the content), a cognate boost input 614, where cognates (i.e., words having the same linguistic derivation in both languages) may be considered as known faster than other words because a word in a new language that sounds or is written similarly to a word in the native language is easier to guess, particularly in context, and an idiomatic expression detection 616, where all individual words in an idiomatic expression may be considered common, but their meaning changes in context and it is important to translate the expression as a unit (e.g., “that's not my cup of tea”).

Pursuant to some embodiments, a dynamic familiarity computation 620 reflects how much a user has been exposed to a word through cumulative content consumption and the spacing between those exposures. It receives input from a cumulative exposure history 622 (tracking how many times the user has encountered each word), a spaced repetition analysis 624 (accounting for the temporal distribution of exposures, since a word seen twelve times over a month at regular intervals is more likely to be retained than one seen twelve times in a single session), and feedback signals input 626 collected from user interaction. Dynamic familiarity may also vary by linguistic properties; for example, the system may account for differences in retention rates between verbs and nouns, between words with multiple lemmas and words that appear in only one form, and between longer and shorter words.

Pursuant to some embodiments, an assumed familiarity computation 630 is derived from a proficiency level input 632 (e.g., a proficiency level such as the proficiency set via the proficiency selection interface 520 shown in FIG. 5B, or an internal proficiency model) and reflects the likelihood that a speaker at that level would be familiar with a given word or linguistic construct.

Pursuant to some embodiments, the personalized familiarity metric 640 combines the three elements: (1) static familiarity, which is specific to each language pair, (2) dynamic familiarity, which is user-specific and accounts for exposure history, spaced repetition, and feedback signals, and (3) assumed familiarity, which serves as a scaling factor based on the proficiency model. The combined metric feeds the partial translation decision 650, which determines for each word or phrase whether to include translation 652 or omit translation 654.

Pursuant to some embodiments, the personalized familiarity metric 640 is not limited to individual words but extends to grammar constructs, idioms, tenses, and areas of vocabulary. For example, context-based signals 670 may include the user's background/profession 672 and a content domain classification 674 of the current content. If a learner has extensively consumed content in engineering, the system may infer higher familiarity with technical vocabulary in that domain, while inferring lower familiarity with vocabulary related to, e.g., medical topics.

### Feedback Signals

Pursuant to some embodiments, the system collects feedback signals input 626 from user interaction, apart from plain content consumption, that are designed to gather user feedback on familiarity with words and linguistic constructs. Pursuant to some embodiments, these feedback signals may include:

Phrase-based feedback 628: captured when the user interacts with controls in a phrase-by-phrase playback user interface, such as a “request translation” button or a “skip translation” button, or takes similar actions that offer useful functionality and simultaneously capture information about familiarity.

Quiz-based feedback 629: the system 100 presents occasional quizzes (or other interaction based feedback) on learned vocabulary and grammar to reinforce learning and gauge the learner's grasp of the language. These responses may be used as an input to refine the personalized familiarity (discussed above), and allows the system 100 to determine when a partial translation may be useful, when micro-lessons should be used, and to make an overall determination of the user's familiarity with the target language.

Context-based signals 670: the system uses known context about the user's background/profession 672 and the content domain classification 674 to infer whether the user may know or is unlikely to know words in a particular domain.

NLP-based contextual analysis: the system uses NLP to analyze the parts of a phrase. In certain situations, because a word appears in a particular syntactic position, removing it and inserting a blank still leaves the phrase understandable from context. In other situations, the word is critical to comprehension. Research-based methods for identifying the importance of a word in a sentence can be used to manipulate translation decisions accordingly.

To calculate the personalized familiarity metric 640, the learning platform 120 tracks the user's consumption over time via the users data database 182 (FIG. 1B). Some statistics can be precalculated at different stages (e.g., static familiarity at content upload time and dynamic familiarity as the user's consumption events are tracked over time). This results in a desirable user experience, as playback of partially translated content can include an extra pause before and after translated phrases. Further, the playback speed, pace, and context may be varied depending on the user's fluency level.

### Segment Processing and Audio Generation

Reference is now made to FIG. 3, where a segment processing process 300 pursuant to some embodiments is shown. The process 300 begins at 310 where a content segment enters the processing pipeline and is first processed at a split segment into phrases step 320 by the splitter module 170 (FIG. 1B). The output of the splitting step then undergoes a quality control check 325. If the quality control check 325 indicates a deficiency, the learning platform 120 routes to a fallback processing path 327 (as described in detail in the quality control and fallback hierarchy flow 700 of FIG. 7). If the quality control check 325 passes, the system proceeds to a has audio decision 330.

If the content segment does not have existing audio (the “No” path from decision 330), an inject content step 340 tailors the content for the learner (e.g., by adjusting cadence or modifying phrases to match the learner's proficiency). The modified content is then processed at a generate audio step 350 using the text-to-speech engine 190 (FIG. 1B). The generated audio is then available for presentation at a play audio step 390.

If the content segment has existing audio (the “Yes” path from decision 330, e.g., in the case of a podcast or video), a split audio step 360 divides the original audio at phrase boundaries using the audio split bridge 188 (FIG. 1B). A repair audio step 370 then addresses any audio discontinuities caused by the splitting, using the audio editing engine 192 (FIG. 1B). An inject content step 380 inserts additional audio content (e.g., translations, teaching commentary) between repaired phrases. The resulting audio is then available for presentation at play audio step 390.

TTS engines typically convert transcripts to speech and can add timestamps for special markers. The transcript sent to TTS engines may include SSML tags that affect engine behavior, such as a tag to insert a pause and a tag to mark timestamps. Unlike with text, in speech, adjacent words are often not clearly separated. As a result, cutting a sentence between arbitrary words may noticeably distort the audio.

To address the challenge of accurately identifying phrase boundaries in generated audio, some embodiments use SSML mark tags (to insert timestamps) and SSML break tags (to insert delays). A speech pause is strategically added between certain words based on split locations to add enough space in which to cut, without changing how the audio is perceived. Additionally, a known anchor word (e.g., “ah”) may be inserted before and after phrases to provide a deterministically accurate identifier of phrase start and end points. A yet further embodiment utilizes digital signal processing (DSP), for example, to identify silent periods at the beginning and to trim.

Timestamps produced by TTS engines can vary in accuracy, especially for longer transcripts. For these cases, embodiments use a specialized algorithm to correct the timestamps. Timestamps can also vary in how much padding they add before and after words. For these cases, the content can be wrapped with dummy words, and only the now-accurate timestamps between words are used. An alternative approach uses signal processing to detect silence points next to signal segments corresponding to specific words.

For original audio content (e.g., from a podcast), the repair audio step 370 addresses the fact that splitting usually produces distorted audio at cut points. Embodiments utilize an AI model to restore missing suffixes and prefixes of cut words while preserving the original speaker's audio and speech characteristics.

Pursuant to some embodiments, for audio content (e.g., from a podcast or video), a learner may wish to hear the translated version in the original speaker's voice. The learning platform 120 may utilize generative voice models to create translated audio that preserves the same voice print, accent, and speech characteristics as the original speaker. The “specific speaker” whose voice is cloned could be the same person speaking in a different language, a voice actor known from dubbing, or any chosen speaker. If original audio exists in one language, generative AI processing can replicate the speaker's voice characteristics in the translated language.

### Personalized Teaching Voice

To better support audio-based learning, particularly for beginner and intermediate learners, embodiments generate audio using a personalized teaching voice. Standard solutions typically rely on mechanical tempo reduction, which can only be applied within a limited range before speech sounds unnatural.

Pursuant to some embodiments, the text-to-speech engine 190 (FIG. 1B) uses voice models that understand prosody, including syllables, pauses, word boundaries, and emphasis. This allows speech to be produced similarly to how a teacher speaks in a classroom: clearly articulating words, separating them when necessary, and stressing key sounds to aid comprehension.

Teacher speech patterns may vary not only by the learner's fluency level but also depending on the learner's native language. For example, an English teacher may use different pacing and emphasis when speaking to Korean-speaking learners compared to Chinese-speaking or Spanish-speaking learners.

A challenge with personalized teaching voice is that training audio generation models requires hours of training data. An alternative is to use zero-shot or one-shot voice cloning. Once generated, the voice can be slowed slightly further (e.g., by an additional 10-15%) without degrading quality. For common scenarios and language combinations, a dedicated slow voice model can be trained using carefully recorded speech from professional voice actors adopting a teacher-style delivery.

### Video Content Processing

In some embodiments, the item of content is video, processed by the video service 186 (FIG. 1B). Video presents a challenge because the visual scene must be in sync with the audio. Embodiments utilize a number of processing features including: (i) adapting the content to proficiency and learning goals and then regenerating the audio via the text-to-video engine 196, resulting in output resembling dubbing, (ii) overlaying textual content over the existing video using the video editing engine 198 to display both original and translated phrases, and (iii) allowing the learner control over the amount of additional content displayed or narrated.

It is technically difficult to incorporate extra audio into a given video scene since existing audio is often tightly synchronized with the video. The system addresses this challenge by manipulating the original audio in selected locations to make room for extra audio (by speeding up audio where lip-syncing is not an issue, adapting audio to generate equivalent meaning with shorter duration, and selectively translating only words predicted to be meaningful), and by slowing down the original stream in selected locations (by exploiting gaps between words, creating new gaps, and extending scenes where lip-syncing is not visible).

### Micro-Lessons and Content Enrichment

The enrich module 166 and micro-lesson module 174 (FIG. 1B) provide context-rich learning additions. Micro-lessons are small, focused lessons designed to teach specific, well-defined teaching concepts. Each micro-lesson covers a narrow topic, making learning manageable and efficient. Examples in the context of language learning include vocabulary, grammar rules, idioms, syntax, pronunciation, comprehension, slang, and more.

Pursuant to some embodiments, a collection of micro-lessons can be organized by dependencies (lessons with prerequisites), ranked by importance, and assigned repetition requirements (count, frequency). Pursuant to some embodiments, micro-lessons are integrated into existing content by: (1) adaptation (edit/replace) of existing content, for example replacing words to teach new vocabulary or changing sentence structure to teach grammar forms, and (2) extension (append/inject) of existing content, for example adding commentary, examples, or repeated words.

The micro-lesson module 174 includes a micro-lesson integration planner that, given content broken into phrases, learning objectives with repetitions, a directed acyclic graph (DAG) of dependencies between objectives, distribution parameters, and timing data, produces an ordered list of objectives with insertion points, reference content, and micro-lesson parameters including duration, location (inline or end of phrase), relation to content, and whether to adapt or extend.

Users can save unknown or difficult words or phrases for later review via a saved words/memorization user interface, and the memorize module 172 (FIG. 1B) generates memorization aids using associations that link pronunciation with meaning.

Pursuant to some embodiments, the memorize module 172 generates memorization content using phonetic association techniques. For example, the learning platform 120 may identify a word in the foreign language that sounds similar to a word in the learner's native language, and generate an explanatory mnemonic linking the two. As an illustrative example, when learning the Spanish word “suscripción” (meaning “subscription”), the system may generate the association: “the word sounds like ‘suspicion’—imagine being suspicious of every new subscription.” Such phonetic association mnemonics help learners understand, digest, and remember new or difficult vocabulary.

Pursuant to some embodiments, content enrichment (also referred to as extra content injection) adds material to the original adapted content in various forms to enhance the learning process and user experience. Extra content may include additional text (optionally narrated), visual content (graphics, images, icons, animations), sound cues (e.g., special sounds to mark points of interest), and visual cues (e.g., blinking, color highlighting, overlay frames, and the like). In the case of narrated enrichment content, it may be distinguished from the original adapted content implicitly by speech features (e.g., a distinct narrator voice, pitch, or accent) or explicitly by audio cues (e.g., an announcement sound marking the beginning and end of the extra content). These enrichment mechanisms allow the system to layer additional learning value onto the adapted content without disrupting the learner's engagement with the primary material.

### Additional Learning Enhancement Techniques

A number of additional techniques may be used to enhance learning, including: (1) volume control, where different volumes are used for different speakers, languages, phrases, or enriched content to mark importance and train the learner's brain to pay attention, (2) spatial control, where spatial audio is used to make audio appear to originate from specific locations relative to the learner, (3) pause management, where the pause between foreign and native language phrases is optimized based on learner proficiency, phrase length, linguistic complexity, and learner preferences, and (4) voice selection, where AI voices are tailored to the learner's proficiency and learning goals.

Additional techniques include: (1) grammar-based marking, where words are marked based on grammatical role, difficulty, or construct, visually or in audio, (2) reference injection, where a reference word is added to clarify ambiguity when word ordering between content and translation deviates noticeably, and (3) constructive memorization, using methods to help learners understand, digest, and remember new or difficult words or grammar.

### Client-Server Interaction

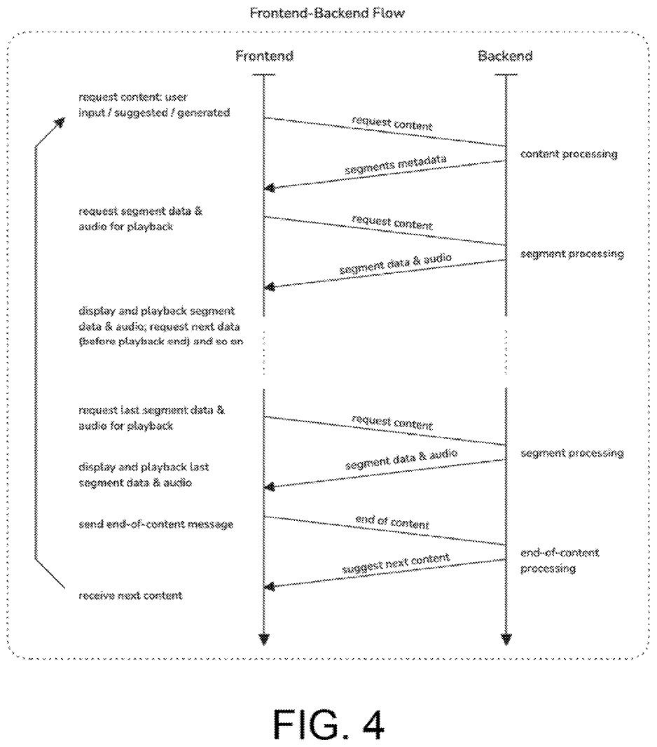

Reference is now made to FIG. 4 where interaction between a frontend and a backend of the learning platform 120 is shown. The frontend 410 (which generates user interfaces for display to the learner via a learner device 110) communicates with the backend 420 (which performs content processing and segment processing and implemented as the learning platform 120 of FIG. 1B). The learner requests content via a request content message 430. The backend 420 performs content processing 434 (as described in FIG. 2) and returns a segments metadata response 432 to the frontend 410.

When the learner interacts with a segment, the frontend 410 sends a request segment data and audio message 440 to the backend 420. The backend 420 performs segment processing 444 (as described in FIG. 3) and returns a segment data and audio response 442 to the frontend 410 for playback in a phrase-by-phrase playback user interface. This continues as the learner works through the content.

Pursuant to some embodiments, the communication between the frontend 410 and the backend 420 may be synchronous or asynchronous (event-driven). FIG. 4 is illustrative and does not imply a fixed synchronous communication pattern. In asynchronous implementations, the frontend 410 does not block while waiting for the backend 420 to complete processing; instead, the frontend 410 is notified when processed content is available.

When the learner reaches the end of the content, an end-of-content message 450 is sent. The backend 420 performs end-of-content processing 454 and returns a suggest next content message 452 to the frontend 410. The next item of content may be determined based on the results of the learner's interaction with the previous content.

### On-Device Processing

Pursuant to some embodiments, some of the computation may be performed on the learner device 110 rather than on the backend 420. Modern devices are increasingly capable and have growing AI capabilities. Certain processing tasks, such as text-to-speech rendering and speech-to-text transcription, can be offloaded to the learner device 110, reducing server load and potentially reducing latency. The system may dynamically determine which processing tasks to perform on the backend 420 and which to perform on the learner device 110 based on factors such as device capabilities, network conditions, and processing requirements.

### Computing Environment

The learning platform 120 and the other elements of the learning system 100 might be associated with computing devices such as laptop computers, smartphones, servers, and other computing components including databases or similar storage devices. According to some embodiments, the learning platform 120 is automated in that the learning content and information presented to learners via learner devices 110 may be automatically selected and/or generated. As used herein, the term “automated” may refer to actions that can be performed with little or no intervention by a human. The processes described herein may be implemented.

Devices described herein may exchange information via any communication network, which may be one or more of a Local Area Network (LAN), a Metropolitan Area Network (MAN), a Wide Area Network (WAN), a proprietary network, a Public Switched Telephone Network (PSTN), a wireless network, a Bluetooth network, a wireless LAN network, and/or an Internet Protocol (IP) network such as the Internet, an intranet, or an extranet.

The flow charts and diagrams described herein do not imply a fixed order to the steps, and embodiments may be practiced in any order that is practicable. Any of the methods described herein may be performed by hardware, software, or any combination of these approaches. For example, a computer-readable storage medium may store thereon instructions that when executed by a machine result in performance according to any of the embodiments described herein.

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A computer-implemented system for personalized learning through content consumption, the system comprising:
one or more processors; and
one or more non-transitory computer-readable storage media storing instructions that, when executed by the one or more processors, cause the system to:
receive, from a client device in communication with a learning platform, information identifying an item of content;
process the item of content to generate a plurality of segments, wherein processing the item of content comprises adapting the item of content based on at least one of a proficiency of a user, a level of difficulty of the item of content, and a learning goal of the user;
split each segment into a plurality of phrases based on linguistic analysis of the content, wherein a target phrase length is determined based on the proficiency of the user;
generate, for each phrase, audio content in a foreign language and corresponding translated content in a native language of the user; and
present, via the client device, the plurality of phrases to the user in an audio-first format that alternates between the foreign language and the native language.

2. The system of claim 1, wherein splitting each segment into the plurality of phrases comprises applying a natural language processing (NLP) algorithm that accounts for Part-of-Speech tags, Dependency Parsing, and Constituency Trees to preserve natural language boundaries including pauses at punctuation and to maintain compound words as unified phrases.

3. The system of claim 1, further comprising instructions that cause the system to:
submit a processing task to a first language model;
perform quality control on an output of the first language model, the quality control comprising at least one of a syntactic check and a semantic check;
upon detecting a quality deficiency, apply at least one of (i) a structural remediation to correct a formatting error in the output, (ii) a retry with an adapted prompt in an agentic mode, (iii) a retry with a second language model that is more capable than the first language model, and (iv) a fallback to a deterministic NLP-based processing approach.

4. The system of claim 1, wherein generating audio content comprises:
inserting SSML mark tags and SSML break tags into a transcript to be processed by a text-to-speech engine;
inserting anchor words at phrase boundaries to provide deterministically accurate identifiers of phrase start and end points; and
generating the audio content using the text-to-speech engine with the inserted tags and anchor words.

5. The system of claim 1, wherein the item of content comprises audio content, and wherein processing the item of content further comprises:
performing speaker diarization to identify and separate different speakers within the audio content;
transcribing the audio content into text with speaker attribution; and
generating translated audio using different synthesized voices for different speakers.

6. The system of claim 1, wherein the item of content comprises written content, and wherein processing the item of content further comprises adapting the written content for audio delivery by:
detecting, using NLP, visual-dependent elements comprising at least one of figure references, footnotes, abbreviations, and formatting cues; and
rewriting, using an LLM, the detected visual-dependent elements into audio-friendly equivalents.

7. The system of claim 1, further comprising instructions that cause the system to generate, via a transliterate module, a transliteration of the foreign language content to a script familiar to the user when the foreign language uses a non-Latin script, and to present the transliteration on-screen in synchronization with the audio content.

8. The system of claim 1, wherein at least a portion of the processing is performed on the client device rather than on a server, the portion comprising at least one of text-to-speech rendering and speech-to-text transcription.

9. The system of claim 1, further comprising instructions that cause the system to translate the item of content using a delimiter-based translation approach comprising:
splitting source language content into phrases using NLP;
inserting mark delimiters at phrase boundaries in the source language content;
translating the delimited content to a target language while retaining the delimiters;
splitting the translated content by the retained delimiters; and
matching the resulting target language phrases with the corresponding source language phrases.

10. The system of claim 1, further comprising instructions that cause the system to translate the item of content using a trace marker translation approach comprising:
splitting source language content into phrases using NLP;
adding trace markers to the resulting phrases;
translating the marked phrases to a target language while retaining the trace markers;
removing the trace markers from the translated phrases using NLP; and
matching the resulting target language phrases with the corresponding source language phrases based on the trace markers.

11. The system of claim 1, further comprising instructions that cause the system to translate the item of content using a cross-lingual alignment approach comprising:
translating the item of content from a foreign language to a native language of the user;
splitting the item of content in the foreign language into phrases using NLP; and
aligning the foreign language phrases with matching phrases in the translated native language content using a cross-lingual alignment model.

12. The system of claim 1, further comprising instructions that cause the system to:
divide the adapted content among a plurality of speakers, each speaker representing at least one of a language, a role, a narration function, and an identified speaker from the item of content; split each speaker's content into phrases; and
present the content by rotating among the plurality of speakers in a preset order, such that each speaker delivers one corresponding phrase per rotation until all phrases have been presented.

13. The system of claim 1, wherein splitting each segment into the plurality of phrases further comprises reordering words within at least one phrase to account for differences in word order between the foreign language and the native language of the user while preserving the semantic meaning of the phrase.

14. The system of claim 1, further comprising instructions that cause the system to:
for audio content comprising an original speaker's voice, generate translated audio that preserves a voice print and speech characteristics of the original speaker using a generative voice model.

15. A computer-implemented system for integrating micro-lessons into personalized learning content, the system comprising:
one or more processors; and
one or more non-transitory computer-readable storage media storing instructions that, when executed by the one or more processors, cause the system to:
receive content that has been divided into a plurality of phrases;
receive a set of learning objectives organized as a directed acyclic graph of dependencies with associated repetition requirements;
for each learning objective, identify candidate insertion points within the plurality of phrases based on a computed fit between the learning objective and a context window of one or more adjacent phrases;
select, from among the candidate insertion points, an optimal insertion point based on a value function that accounts for objective priority, repetition status, and context fit; and
generate a micro-lesson at the selected insertion point, the micro-lesson comprising at least one of an adaptation of existing content and an extension of existing content with supplemental teaching material.

16. The system of claim 15, wherein the instructions further cause the system to:
employ a hierarchy of language models, wherein a first processing attempt uses a smaller, faster language model, and upon a quality control failure, processing escalates to a larger, more capable language model; and
upon failure of all language models in the hierarchy, fall back to a deterministic NLP-based processing approach.

17. A computer-implemented method for quality-controlled content processing in a learning system, the method comprising:
submitting, by one or more processors, a content processing task to a first language model;
performing a syntactic quality check on an output of the first language model, the syntactic quality check comprising at least one of formatting validation, delimiter validation, and length validation;
performing a semantic quality check on the output, the semantic quality check comprising at least one of a parts-of-speech comparison using natural language processing and a meaning preservation query using a language model;
upon detecting a failure in at least one of the syntactic quality check and the semantic quality check, applying a cascading series of fallback methods comprising:
attempting structural remediation to correct formatting errors;
retrying the task with an adapted prompt in an agentic mode;
retrying the task with a second language model that is more capable than the first language model; and
falling back to deterministic NLP-based processing; and
producing validated output for delivery to a learner.

18. The method of claim 17, further comprising performing offline quality control on sampled outputs of the content processing task, and using results of the offline quality control to tune thresholds and parameters of the syntactic quality check and the semantic quality check.

19. A computer-implemented method for partial translation in a learning system, the method comprising:
computing, by one or more processors, a personalized familiarity metric for each of a plurality of words in content to be presented to a learner, wherein the personalized familiarity metric is based on a combination of:
a static familiarity component based on at least a base word frequency in a foreign language and a cognate similarity between the foreign language and a native language of the learner;
a dynamic familiarity component based on at least a cumulative exposure history of the learner to each word and a temporal spacing of the exposures; and
an assumed familiarity component based on a proficiency level of the learner;
determining, based on the personalized familiarity metric for each word, whether to include or omit a translation of the word; and
generating audio content for the learner that includes translations selectively based on the determining step.

20. The method of claim 19, wherein the dynamic familiarity component further accounts for at least one of (i) a difference in retention rates between different parts of speech, (ii) a difference in retention rates based on word length, and (iii) a number of lemma forms of each word.

21. The method of claim 19, further comprising:
collecting feedback signals from the learner, the feedback signals comprising at least one of (i) phrase-based feedback captured when the learner activates a request-translation or skip-translation control, (ii) quiz-based feedback from vocabulary and grammar quizzes presented to the learner, and (iii) context-based signals derived from the learner's background and a content domain classification; and updating the dynamic familiarity component based on the collected feedback signals.

22. The method of claim 19, further comprising implementing reverse partial translation for a beginner-level learner, wherein reverse partial translation comprises:
playing content in the native language of the learner;
selecting, based on learning objectives and a lesson plan, a subset of words and phrases from the content; and
translating and playing only the selected subset in the foreign language to gradually introduce foreign language elements.

23. The method of claim 19, wherein the static familiarity component further comprises detecting idiomatic expressions in the content and treating the idiomatic expression as a unit for translation regardless of the familiarity of individual words within the expression.

24. The method of claim 19, wherein computing the personalized familiarity metric further comprises incorporating context-based signals, the context-based signals comprising at least a user background identifying a profession or area of expertise, and a content domain classification of the content, to adjust the personalized familiarity metric for domain-specific vocabulary.
